(19) United States
(12) Patent Application Publication
(10) Pub. No.: US 2026/0088556 A1
(43) Pub. Date: Mar. 26, 2026

(54) RELIABLE COMPACT CONNECTOR FOR HIGH-CURRENT, LOW-CURRENT, AND SIGNAL TRANSMISSION

(71) Applicant: FCI Connectors Dongguan LTD., Dongguan City (CN)

(72) Inventors: Yilin Liu, Dongguan (CN); Yiheng Wang, Dongguan (CN)

(73) Assignee: FCI Connectors Dongguan LTD., Dongguan City (CN)

(21) Appl. No.: 19/342,081

(22) Filed: Sep. 26, 2025

(30) Foreign Application Priority Data
Sep. 26, 2024 (CN) 202422548616.4
Oct. 14, 2024 (CN) 202422548415.4

(51) Int. Cl. H01R 13/502; H01R 12/70; H01R 12/72; H01R 13/64; H01R 27/02

(52) U.S. Cl. CPC H01R 13/502; H01R 12/7088; H01R 12/724; H01R 13/64; H01R 27/02

(57) ABSTRACT

A reliable, compact connector for high-current, low-current, and signal transmission comprising a connector housing accommodating high-power terminals, low-power terminals, and signal terminals. Each terminal can include projections, detents, and/or elastic arms that cooperate with the connector housing to achieve stable mounting, precise positioning, and enhanced retention force. In some embodiments, the high-power terminal is further secured by multiple detents and an elastic arm, while the signal and low-power terminals are supported by corresponding projections and elastic arms. The connector may be implemented in a modular architecture in which housing sections and terminal groups are configurable to support different current capacities and signal requirements. Such a configuration reduces the overall volume of the connector, facilitates easy assembly without requiring a large installation space, and ensures consistent conduction with minimized disconnection, thereby providing improved durability and extended service life in applications involving high-current, low-current, and signal transmission.

### CROSS-REFERENCE TO RELATED APPLICATIONS

This application claims priority to and the benefit of Chinese Patent Application No. 202422548415.4, filed on Oct. 14, 2024. This application also claims priority to and the benefit of Chinese Patent Application No. 202422548616.4, filed on Sep. 26, 2024. The contents of these applications are incorporated herein by reference in their entirety.

### TECHNICAL FIELD

The present disclosure relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several electronic subassemblies is to have one printed circuit board serve as a backplane. A known backplane is a PCB onto which many connectors may be mounted. Conducting traces in the backplane may be electrically connected to signal conductors in the connectors such that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

### SUMMARY

Aspects of the present disclosure relate to reliable compact connector for high-current, low-current, and signal transmission.

Some embodiments relate to an electrical connector. The electrical connector may comprise a housing comprising a first section, a second section, and a third section, the second section joining the first section and the third section; a plurality of first terminals held in the first section of the housing, each of the plurality of first terminals configured to carry a first maximum current; a plurality of second terminal wafers held in the second section of the housing, each of the plurality of second terminal wafers comprising a plurality of second terminals held by a wafer housing; and a plurality of third terminals held in the third section of the housing, each of the plurality of third terminals configured to carry a second maximum current less than the first maximum current.

Optionally, the first section of the housing comprises a plurality of first slots, each first slot holding a plurality of first terminals; the second section of the housing comprises a plurality of second slots, each second slot holding a respective second terminal wafer of the plurality of second terminal wafers; and the third section of the housing comprises a plurality of third slots, each third slot holding a respective third terminal of the plurality of third terminals.

Optionally, the first section of the housing comprises a plurality of first grooves, and a plurality of second grooves; and each of the plurality of first terminals comprises a mating end, and a tail, and an intermediate portion between the mating end and the tail, the intermediate portion comprising an elastic arm configured to engage a respective first groove of the plurality of first grooves and a projection configured to engage a respective second groove of the plurality of second grooves.

Optionally, for each of the plurality of first terminals, the intermediate portion comprises a detent configured to engage a top of the first section of the housing.

Optionally, the second section of the housing comprises a plurality of recesses; and the wafer housing of each of the plurality of second terminal wafers comprises a projection disposed in a respective recess of the plurality of recesses.

Optionally, for each of the plurality of second terminal wafers, the wafer housing comprises an elastic arm configured to engage a top of the second section of the housing.

Optionally, the second section of the housing comprises a plurality of ribs protruding into respective second slots; and the wafer housing of each of the plurality of second terminal wafers is configured to engage ribs of the plurality of ribs protruding into the respective second slot.

Optionally, the third section of the housing comprises a plurality of grooves; and each of the plurality of third terminals comprises a mating end, and a tail, and an intermediate portion between the mating end and the tail, the intermediate portion comprising a projection configured to engage a respective groove of the plurality of grooves of the third section of the housing.

Some embodiments relate to an electrical connector. The electrical connector may comprise a housing comprising a first section comprising a plurality of first slots, a second section comprising a plurality of second slots, and a third section comprising a plurality of third slots, the second section joining the first section and the third section; a plurality of pairs of first terminals held in the first section of the housing, each pair of the plurality of pairs of first terminals disposed in a respective first slot; a plurality of second terminal wafers held in the second section of the housing, each of the plurality of second terminal wafers comprising a plurality of second terminals held by a wafer housing, each of the plurality of second terminal wafers disposed in a respective second slot; and a plurality of third terminals held in the third section of the housing, each of the plurality of third terminals disposed in a respective third slot.

Optionally, the second section and the third section are separated by a wall; and the first section and the second section are separated by a partial wall having a plurality of projections extending therefrom in a mating direction of the electrical connector.

Optionally, adjacent first slots of the plurality of first slots are separated by respective partial walls each having a plurality of projections extending therefrom in the mating direction of the electrical connector.

Optionally, adjacent third slots of the plurality of third slots are separated by respective partial walls each having a plurality of projections extending therefrom in the mating direction of the electrical connector.

Optionally, each first terminal of the plurality of pairs of first terminals comprises a mating end, and a tail, and an intermediate portion between the mating end and the tail; each of the plurality of second terminals comprises a mating end extending beyond a first edge of the wafer housing, and a tail extending beyond a second edge of the wafer housing, and an intermediate portion between the mating end and the tail; and each of the plurality of third terminals comprises a mating end, and a tail, and an intermediate portion between the mating end and the tail.

Optionally, the mating ends of the first terminals are shaped as beams; and the mating ends of the second and third terminals are shaped as blades.

Optionally, the mating ends of the first terminals are shaped as blades; and the mating ends of the second and third terminals are shaped as beams.

Optionally, each first terminal comprises a first side and a second side opposite the first side; the mating end of each first terminal comprises a plurality of beams each having a contact face on one of the first and second sides; and the intermediate portion of each first terminal comprises a projection protruding from the one of the first and second sides, and an elastic arm extending outwardly from the one of the first and second sides.

Optionally, each third terminal comprises a first side and a second side opposite the first side; the mating end of each third terminal comprises a first beam, and a second beam looped around the first beam and extending outwardly from one of the first and second sides; and the intermediate portion of each third terminal comprises an elastic arm extending outwardly from the one of the first and second sides.

Some embodiments relate to an electrical connector. The electrical connector may comprise a housing comprising a first section comprising a plurality of first slots, a second section comprising a plurality of second slots, and a third section comprising a plurality of third slots, the second section joining the first section and the third section; a plurality of first

terminals held in the first section of the housing and disposed in respective first slots, each of the plurality of first terminals comprising an elastic arm configured to engage an adjacent side a respective first slot; a plurality of second terminal wafers held in the second section of the housing and disposed in respective second slots, each of the plurality of second terminal wafers comprising a plurality of second terminals held by a wafer housing, the wafer housing comprises an elastic arm configured to engage a top of the second section of the housing; and a plurality of third terminals held in the third section of the housing and disposed in respective third slots.

Optionally, the first and third sections of the housing comprise guiding projections extending from a top.

Optionally, for each of the plurality of second terminal wafers, the wafer housing comprises a pair of projections on opposite sides and configured to engage sides of a respective second slot.

Some embodiments relate to a high-current right-angle board connector. The connector may comprise a connector housing inside which a high-power terminal, a signal terminal and a low-power terminal are provided, wherein a high-power terminal projection and a high-power terminal detent are provided on the high-power terminal; the high-power terminal projection cooperates with a groove on the connector housing to prevent the high-power terminal from rotating relative to the connector housing when an external force is applied; the high-power terminal detent and the connector housing are in an interference fit to provide a retention force between the high-power terminal and the connector housing; the high-power terminal elastic arm cooperates with a groove on the connector housing to prevent the high-power terminal from depinning relative to the connector housing when an external force is applied; a wafer housing elastic arm and a wafer housing projection are provided on a plastic body holding the signal terminal, wherein the wafer housing elastic arm prevents the signal terminal from depinning in the connector housing, and the wafer housing projection limits the signal terminal from rotating in the housing when an external force is applied; a low-power terminal projection and a low-power terminal detent are provided on the low-power terminal, and the low-power terminal projection and the low-power terminal detent are both in interference fit with the connector housing to provide a retention force between the low-power terminal and the connector housing.

Optionally, the connector housing comprises a first slot, a second slot and a third slot; the high-power terminal is mounted in the first slot; the signal terminal is mounted in the second slot, and the low-power terminal is mounted in the third slot.

Optionally, a high-power terminal elastic arm is further provided on the high-power terminal, and the high-power terminal elastic arm cooperates with the groove on the connector housing to provide a retention force between the high-power terminal and the connector housing.

Optionally, the groove is provided in the first slot to reduce fatigue of the high-power terminal elastic arm when the high-power terminal is interference-fitted with the connector housing.

Optionally, a rib is provided in the second slot, and the signal terminal and the rib are in an interference fit to provide a retention force between the signal terminal and the connector housing.

Optionally, the third slots are provided in plurality and are evenly spaced apart in the connector housing.

Optionally, a lateral positioning projection is further provided on the low-power terminal.

Optionally, a board is further comprised, and the high-current right-angle board connector is soldered on the board for current and signal control.

Optionally, a recess is provided on the connector housing to meet electrical performance requirements of the low-power terminal to withstand high voltage.

Some embodiments relate to a high-current composite board connector. The connector may comprise a connector housing and a high-power terminal, a signal terminal and a low-power terminal located in the connector housing, wherein the high-power terminal is mounted in the connector housing through a first detent and a second detent, and a high-power terminal elastic arm and a high-power terminal projection are provided on the high-power terminal to facilitate mounting the high-power terminal into the connector housing; a wafer housing elastic arm and a wafer housing projection are provided on the wafer housing to facilitate mounting the signal terminal into the connector housing; a low-power terminal elastic arm is provided on the low-power terminal to facilitate mounting the low-power terminal into the connector housing.

Optionally, the connector housing is provided therein with a first housing, a second housing and a third housing for holding the high-power terminal, the signal terminal and the low-power terminal respectively.

Optionally, a groove is provided in the first housing, and the groove cooperates with the high-power terminal.

Optionally, the first housing is provided therein with a recess, and the recess cooperates with the high-power terminal projection.

Optionally, a plurality of ribs are provided in the second housing, and the ribs cooperate with the signal wafer to facilitate positioning the signal terminal.

Optionally, a recess is provided on the second housing, and the recess cooperates with the wafer housing projection.

Optionally, the low-power terminal elastic arm is an arc-shaped structure to facilitate positioning the low-power terminal.

Optionally, a plurality of guiding projections are provided on the connector housing to facilitate positioning and mounting the connector housing.

Optionally, a board is further comprised, and the connector is soldered on the board for current and signal control.

These techniques may be used alone or in any suitable combination. The foregoing summaries are provided by way of illustration and are not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a bottom, rear perspective view of an electrical connector, according to some embodiments.

FIG. 2 is a top, front perspective view of the electrical connector of FIG. 1, showing a portion of a circuit board that contains a footprint for the connector.

FIG. 3 is a top, rear perspective view of a connector housing of the electrical connector of FIG. 1.

FIG. 4 is a perspective view of a high-power terminal of the electrical connector of FIG. 1.

FIG. 5 is a perspective view of a signal terminal of the electrical connector of FIG. 1.

FIG. 6 is a perspective view of a low-power terminal of the electrical connector of FIG. 1.

FIG. 7 is a perspective view of an electronic system comprising an electrical connector and a circuit board, showing a portion of the circuit board that contains a footprint for the electrical connector.

FIG. 8 is a top view of a high-power module of the electrical connector shown in FIG. 7, the high-power module comprising a first housing and a high-power terminal.

FIG. 9 is a cross-sectional view of the high-power module of FIG. 8 along a line marked “A-A” in FIG. 8.

FIG. 10 is a perspective view of the high-power terminal shown in FIG. 8.

FIG. 11 is a perspective view of a second housing of the electrical connector shown in FIG. 7.

FIG. 12 is a perspective view of a signal terminal of the electrical connector shown in FIG. 7.

FIG. 13 is a perspective view of a low-power terminal of the electrical connector shown in FIG. 7.

### DETAILED DESCRIPTION

The inventors have recognized and appreciated connector design techniques that enable reliable compact connectors in applications involving high-current, low-current, and signal transmission. The inventors have recognized and appreciated challenges in integrating terminals configured for different purposes in a single connector, as such terminals may require different retention forces. Conventional connectors are often large, thereby requiring a large footprint on a board. Furthermore, their internal structures are frequently unstable, leading to conduction and disconnection issues during actual use that compromise connector reliability.

The techniques described herein may address these challenges by, for example, providing a modular and configurable connector architecture in which high-power terminals, low-power terminals, and signal terminals are combined within a common housing. Each module may include projections, detents, and elastic arms that cooperate with the housing to achieve stable

mounting, precise positioning, and enhanced retention force. In some embodiments, the connector may include modular units arranged in parallel to scale current capacity, and selected modules may integrate signal contacts for control or monitoring. This modularity may allow the connector to be tailored to different current ratings, signal requirements, and system constraints without redesigning the entire assembly. Such a configuration may reduce overall connector volume, facilitate easy assembly without requiring a large installation space, and preserve airflow for thermal management. By enabling consistent conduction with reduced risk of disconnection, while also supporting system-level flexibility, such a configuration may provide improved durability, extended service life, and future-proof adaptability in applications involving high-current, low-current, and signal transmission.

According to aspects of the present disclosure, an electronic system may include one or more circuit boards configured for high-current, low-current, and/or signal transmission, interconnected through electrical connectors. Each connector may be configured to support one or more of high-current, low-current, and signal transmission.

In some embodiments, a connector may include a housing comprising a first section configured for high-current terminals, a second section configured for signal terminals, and a third section configured for low-current terminals. The second section may be disposed between the first and second sections. In some embodiments, the second and third sections are separated from each other by a wall. Such a configuration may prevent the lower-current terminals from being disturbed by the high-current terminals.

In some embodiments, the first section may include first slots for holding high-current terminals. In some embodiments, multiple signal terminals may be held by a wafer housing to form a signal wafer. The second section may include second slots for holding signal wafers. In some embodiments, the third section may include third slots for holding low-current terminals.

In some embodiments, the first and second sections may be separated from each other by a partial wall having projections extending therefrom in a mating direction of the connector.

Similarly, adjacent first slots and adjacent third slots may be separated by a respective partial wall having projections extending therefrom in the mating direction of the connector. Such a configuration may reduce obstruction to system cooling airflow.

In some embodiments, the size of each of the first, second, and third sections may be configurable based on individual applications. In some embodiments, the number of slots in each of the first, second, and third sections may be configurable based on individual applications. In some embodiments, a connector may include one or more of the first, second, and third sections in accordance with the requirements of a given application. Such a configuration may enable designers to choose the optimal current-density balance.

In some embodiments, each terminal may include one or more of projections, detents, and/or elastic arms, which may cooperate with the connector housing to achieve stable mounting, precise positioning, and enhanced retention force. In some embodiments, each high-current terminal may include an elastic arm configured to engage a side of a respective first slot, a projection configured to engage the same side of the respective first slot, and/or one or more detents configured to engage a top of the respective first slot. In some embodiments, the wafer housing of each signal wafer may include an elastic arm configured to engage a top of a respective second slot, and/or a projection configured to engage a side of the respective second slot. In some embodiments, each low-current terminal may include a projection and/or an elastic arm configured to engage a side of a respective third slot, and/or one or more detents configured to engage a top of the respective third slot.

In some embodiments, connectors configured to mate with each other may include mating ends shaped complementally to generate desired mating force. In some embodiments, for one of the mating connectors, the high-current terminals may have mating ends shaped as beams, and the low-current terminals and signal terminals may have mating ends shaped as blades. For the other of the mating connectors, the high-current terminals may have mating ends shaped as blades, and the low-current terminals and signal terminals may have mating ends shaped as blades.

The techniques described herein may enable a connector architecture that can provide consistent performance characteristics, such as current rating per terminal and mating force per terminal, while allowing a configurable number of different types of terminals.

In some embodiments, connectors configured to mate with each other may include complementary guiding features. In some embodiments, a connector may include guiding features protruding from a top of the housing, such as from the first and third sections.

According to aspects of the present disclosure, a high-current right-angle board connector may enable the stable mounting and precise positioning of high-power terminals 11, signal terminals 12 and low-power terminals 13. Terminal projections, terminal detents, and elastic arms may cooperate with a connector housing 10 to enhance retention of the high-power terminals 11, the signal terminals 12 and the low-power terminals 13 in the connector housing 10. Such cooperation may prevent damage to the high-current board connector from being damaged in the field, extending the service life of the high-current board connector.

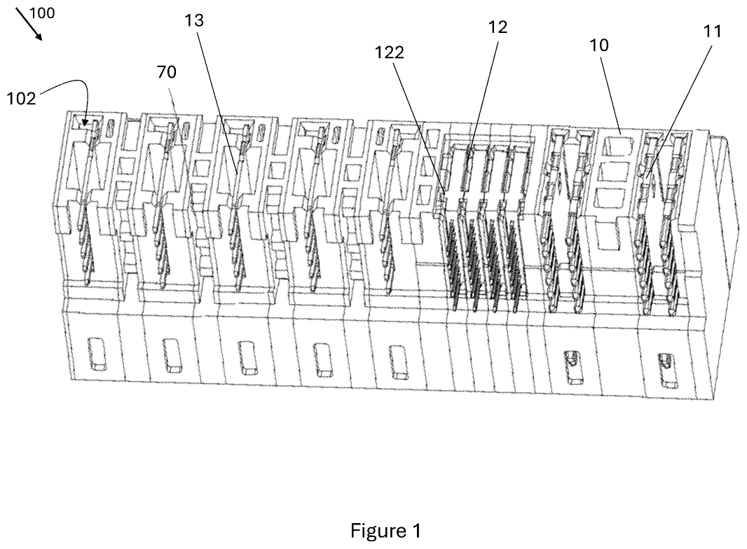

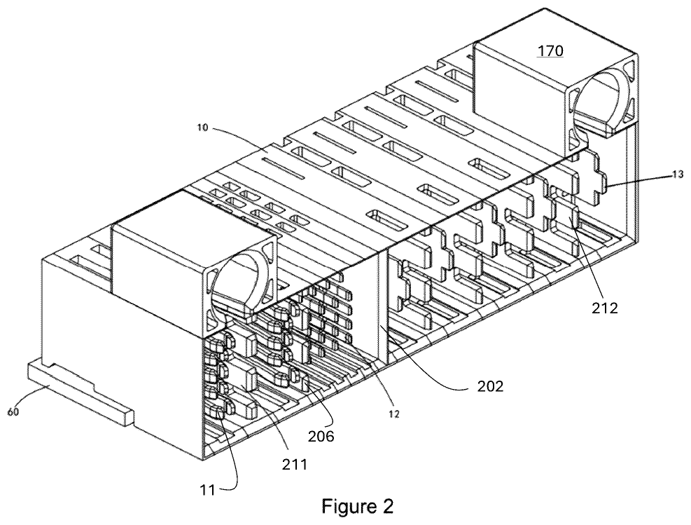

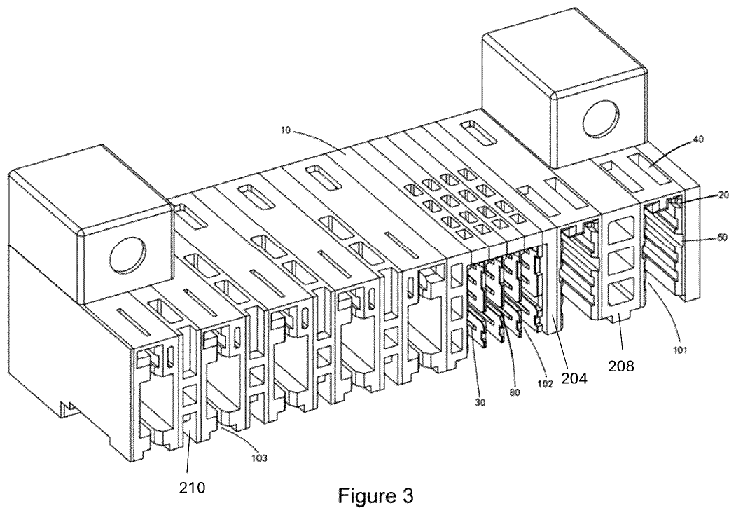

FIG. 1 is a bottom, rear perspective view of an electrical connector, according to some embodiments. FIG. 2 is a top, front perspective view of the electrical connector of FIG. 1, showing a portion of a circuit board 60 that contains a footprint for the connector. FIG. 3 is a top, rear perspective view of a connector housing 10 of the electrical connector of FIG. 1.

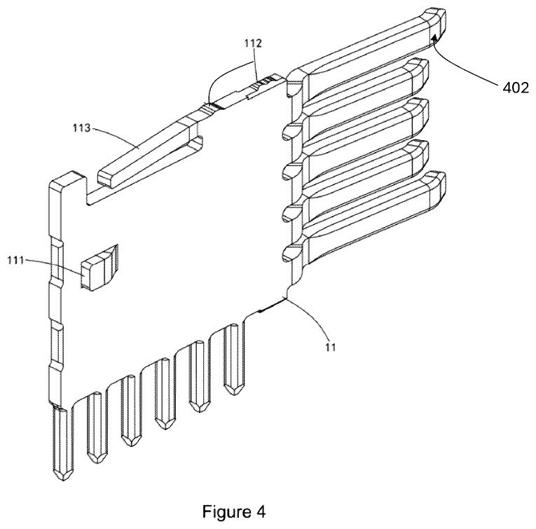

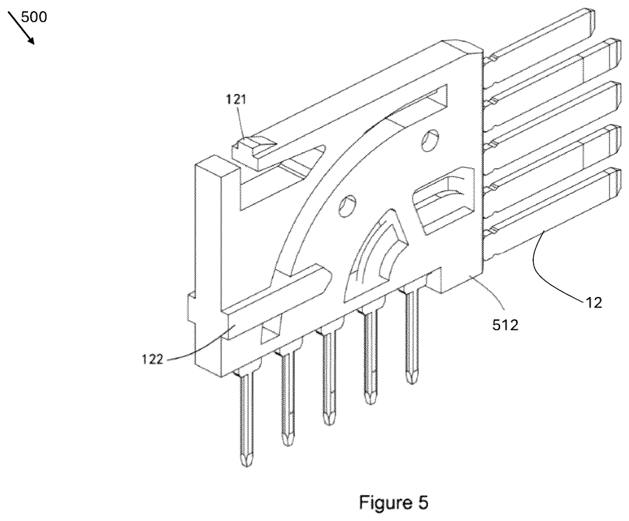

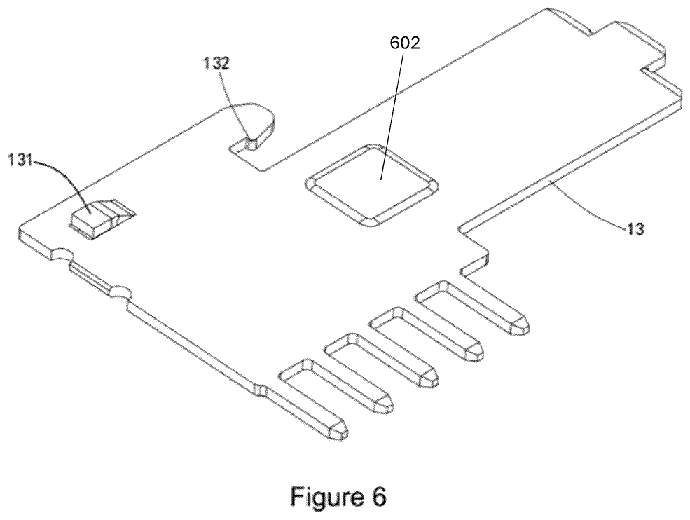

FIG. 4 is a perspective view of a high-power terminal 11 of the electrical connector of FIG. 1. FIG. 5 is a perspective view of a signal terminal 12 of the electrical connector of FIG. 1. FIG. 6 is a perspective view of a low-power terminal 13 of the electrical connector of FIG. 1.

As shown in FIGS. 1 to 6, the high-current right-angle board connector may comprise the connector housing 10, high-power terminals 11, signal terminals 12, and low-power terminals 13. The high-power terminals 11, signal terminals 12, and low-power terminals 13 are stably and accurately mounted within the connector housing 10, forming a reliable compact connector for high-current, low-current, and signal transmission.

In some embodiments, the high-current right-angle board connector may be soldered on a board 60 for signal and current control.

In some embodiments, the connector housing 10 may comprise first slots 101, second slots 102 and third slots 103. The high-power terminals 11 may be mounted in the first slots 101, the signal terminal 12 may be mounted in the second slots 102, and the low-power terminals 13 may be mounted in the third slots 103.

As shown in FIGS. 3 and 4, each high-power terminal 11 may comprise a projection 111 for high-power terminal 11 and a detent 112 for high-power terminal 11. The projection 111 for high-power terminal 11 may cooperate with the groove 50 on the connector housing 10 to prevent the high-power terminal 11 from rotating relative to the connector housing 10 when an external force is applied. The detent 112 for high-power terminal 11 and the connector housing 10 may be in an interference fit to provide a retention force between the high-power terminal 11 and the connector housing 10.

In some embodiments, each high-power terminal 11 may comprise an elastic arm 113 for high-power terminal 11. The elastic arm 113 for high-power terminal 11 may cooperate with a groove 20 on the connector housing 10 to provide a retention force between the high-power terminal 11 and the connector housing 10. The groove 20 may be provided in the first slot 101 to reduce fatigue of the elastic arm 113 for high-power terminal 11 when the high-power terminal 11 is interference-fitted with the connector housing 10.

As shown in FIGS. 3 and 5, a plastic body 512 holding the signal terminal 12 may comprise a wafer housing elastic arm 121 and a wafer housing projection 122. The wafer housing elastic arm 121 may prevent the signal terminal 12 from depinning in the connector housing 10, and the wafer housing projection 122 may prevent the signal terminal 12 from rotating in the housing 10 when an external force is applied. A rib 30 may be provided in the second slot 102, and the signal terminal 12 and the rib 30 may be in an interference fit to provide a retention force between the signal terminal 12 and the connector housing 10. Moreover, a wafer housing projection 122 may be provided on the plastic body 512 to cooperate with a recess 80 of the connector housing 10 to limit the signal terminal 12 from rotating in the connector housing 10 when an external force is applied.

As shown in FIGS. 3 and 6, each low-power terminal 13 may comprise a low-power terminal projection 131 and a low-power terminal detent 132. The low-power terminal projection 131 and the low-power terminal detent 132 may be both in interference fit with the connector housing 10 to provide a retention force between the low-power terminal 13 and the connector housing 10.

In some embodiments, a lateral positioning projection 602 is further provided on the low-power terminal 13, and the lateral positioning projection 602 can effectively prevent the low-power terminal 13 from being mounted incorrectly.

In some embodiments, the third slots 103 are provided in plurality and are evenly spaced apart in the connector housing 10.

In some embodiments, recesses 70 may be hollowed out at the bottom of the connector housing 10 to increase the creepage distance between adjacent terminals, thereby ensuring that adjacent low-power terminals 13 can meet the creepage distance corresponding to the rated voltage and meet the electrical performance requirements of the low-power terminals 13 when in use.

According to aspects of the present disclosure, a high-current composite board connector may include high-power terminals 720, signal terminals 730, and low-power terminals 740. The connector may occupy a compact volume, facilitate field assembly, and avoid the need for a large mounting space. In addition, the internal structure of the connector may be stable, thereby reducing the likelihood of unintended conduction or disconnection in the field and ensuring reliable operation.

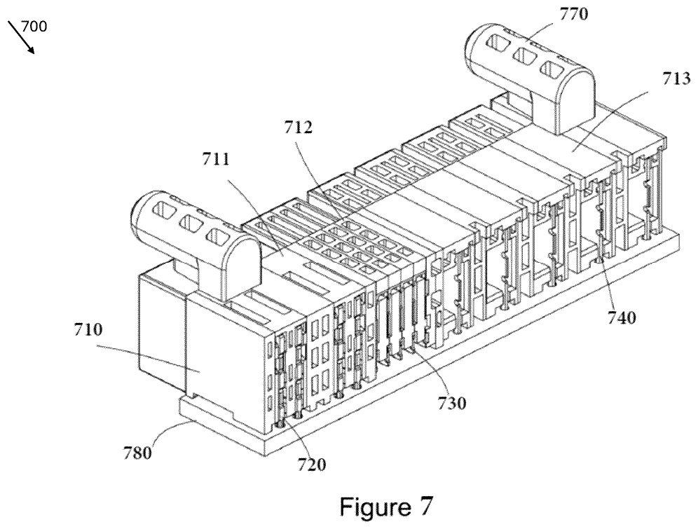

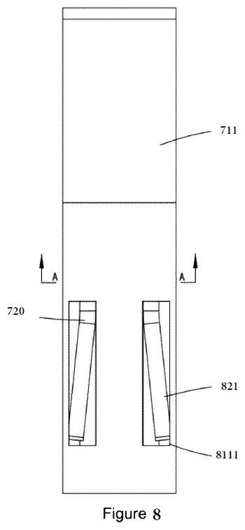

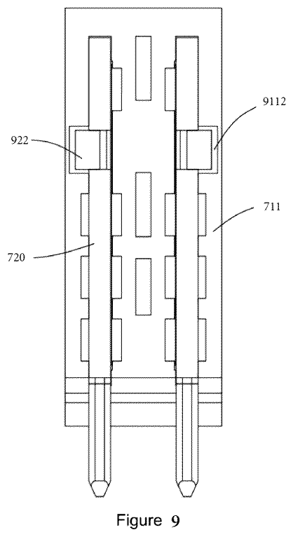

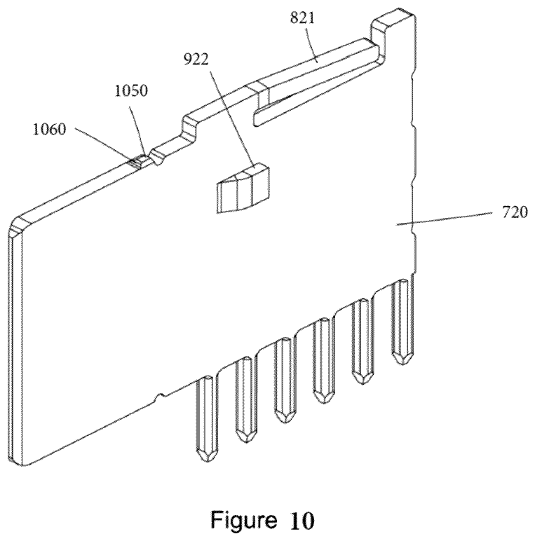

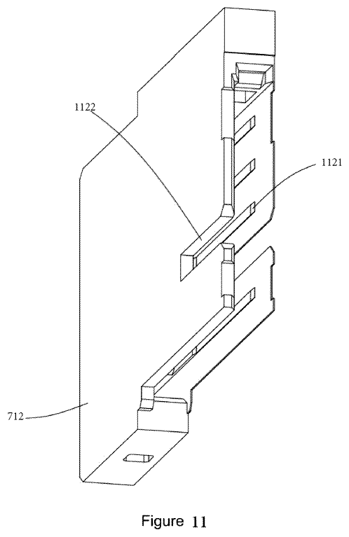

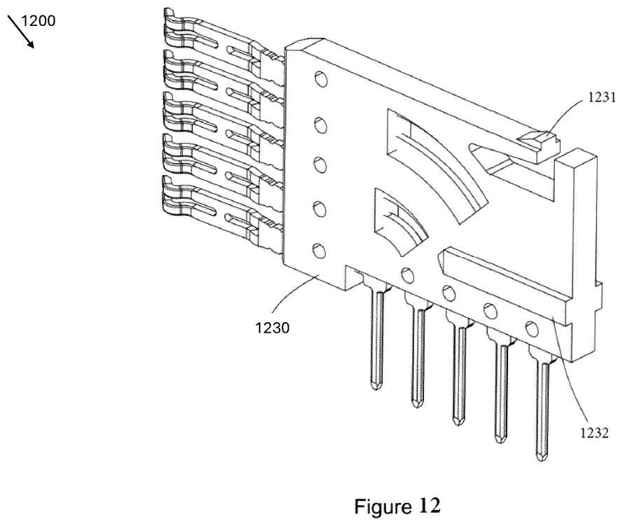

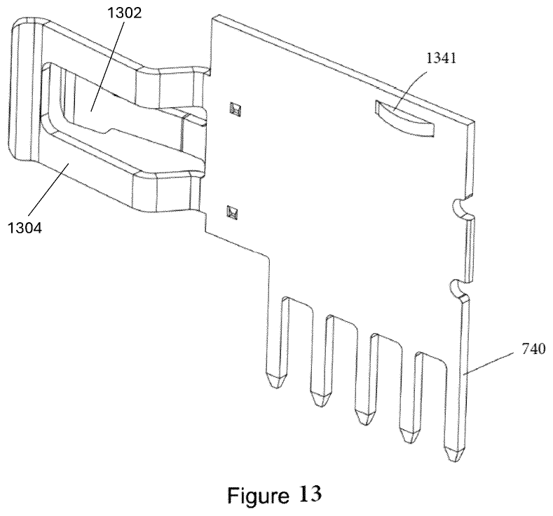

FIG. 7 is a perspective view of an electronic system comprising the electrical connector and a circuit board 780, showing a portion of the circuit board 780 that contains a footprint for the electrical connector. FIG. 8 is a top view of a high-power module of the electrical connector shown in FIG. 7, the high-power module comprising a first housing 711 and a pair of high-power terminals 720. FIG. 9 is a cross-sectional view of the high-power module of FIG. 8 along a line marked “A-A” in FIG. 8. FIG. 10 is a perspective view of the high-power terminals 720 shown in FIG. 8. FIG. 11 is a perspective view of a second housing 712 of the electrical connector shown in FIG. 7. FIG. 12 is a perspective view of a signal terminal of the electrical connector shown in FIG. 7. FIG. 13 is a perspective view of a low-power terminal of the electrical connector shown in FIG. 7.

As shown in FIGS. 7 to 13, the high-current composite board connector may comprise a connector housing 710, and high-power terminals 720, signal terminals 730 and low-power terminals 740 located in the connector housing 710. The connector may be formed by combining the high-power terminals 720, the signal terminals 730, and the low-power terminals 740, thereby occupying a compact volume and convenient to use.

In some embodiments, the connector may be soldered on the board 780 for current and signal control.

In some embodiments, the connector housing 710 may comprise the first housing 711, second housing 712 and third housing 713 for mounting the high-power terminals 720, signal terminals 730, and low-power terminals 740, respectively. A plurality of guiding projections 770 may be provided on the connector housing 710 to facilitate positioning and mounting the connector housing 710.

As shown in FIGS. 7 to 10, the high-power terminal 720 may be mounted in the connector housing 710 through the first detent 1050 and the second detent 1060. A high-power terminal elastic arm 821 and a high-power terminal projection 922 may be provided on each high-power terminal 720 to facilitate mounting the high-power terminal 720 into the connector housing 710. The first detent 1050 and the second detent 1060 can provide a retention force between the high-power terminal 720 and the first housing 711, and the high-power terminal elastic arm 821 can also provide a retention force between the high-power terminal 720 and the first housing 711, for achieving stable mounting of the high-power terminal 720. The presence of the high-power terminal projection 922 can effectively prevent the high-power terminal 720 from rotating after being assembled.

In some embodiments, a groove 8111 may be provided in the first housing 711, and the groove 8111 may cooperate with the high-power terminal 720 to effectively reduce fatigue caused by long-term interference fit between the high-power terminal 720 and the first housing 711. A recess 9112 may be provided in the first housing 711, and the recess 9112 may cooperate with the high-power terminal projection 922 to effectively prevent the high-power terminal 720 from rotating.

As shown in FIGS. 7, 11, and 12, a wafer housing elastic arm 1231 and a wafer housing projection 1232 may be provided on the wafer housing 1230 to facilitate mounting the signal terminal 730 into the connector housing 710. After the signal terminal 730 is mounted, the wafer housing elastic arm 1231 may rebound to prevent the signal terminal 730 from depinning and provide a retention force between the signal terminal 730 and the second housing 712. The wafer housing projection 1232 can accurately position and mount the signal terminal 730 and prevent the signal terminal 730 from rotating after being assembled with the second housing 712.

In some embodiments, a plurality of ribs 1121 may be provided in the second housing 712. The ribs 1121 may cooperate with the signal terminal 730 to facilitate positioning and mounting the signal terminal 730 and provide a retention force. A recess 1122 may be provided on the second housing 712, and the recess 1122 may cooperate with the wafer housing projection 1232 to prevent the signal terminal 730 from rotating after being assembled with the second housing 712.

As shown in FIGS. 7 and 13, a low-power terminal elastic arm 1341 may be provided on the low-power terminal 740 for retaining the low-power terminal 740 in the connector housing 710. The low-power terminal elastic arm 1341 may be a protruding elastic arm, which may interfere with the side of the third housing 713 to provide a retention force with the third housing 713.

In some embodiments, the low-power terminal elastic arm 1341 may be an arc-shaped structure to facilitate positioning the low-power terminal 740.

In some embodiments, the high-current composite board connector of the embodiment may be formed by combining a high-power terminal 720, a signal terminal 730, and a low-power terminal 740. It has a small volume and is easy to assemble in the field, and does not require a large space for mounting. Moreover, the internal structure of the high-current composite board connector of the present disclosure is stable, and the conduction and disconnection will not often occur in actual use, thereby ensuring the stable use of the high-current composite board connector.

Various aspects are described in this disclosure, which include, but may not be limited to, the following aspects:
1. A high-current right-angle board connector, comprising: a connector housing (e.g., 10) inside which a high-power terminal (e.g., 11), a signal terminal (e.g., 12) and a low-power terminal (e.g., 13) are provided, wherein: a high-power terminal projection (e.g., 111) and a high-power terminal detent (e.g., 112) are provided on the high-power terminal (e.g., 11); the high-power terminal projection (e.g., 111) cooperates with a groove (e.g., 50) on the connector housing (e.g., 10) to prevent the high-power terminal (e.g., 11) from rotating relative to the connector housing (e.g., 10) when an external force is applied; the high-power terminal detent (e.g., 112) and the connector housing (e.g., 10) are in an interference fit to provide a retention force between the high-power terminal (e.g., 11) and the connector housing (e.g., 10); the high-power terminal elastic arm (e.g., 113) cooperates with a groove (e.g., 20) on the connector housing (e.g., 10) to prevent the high-power terminal (e.g., 11) from depinning relative to the connector housing (e.g., 10) when an external force is applied; a wafer housing elastic arm (e.g., 121) and a wafer housing projection (e.g., 122) are provided on a plastic body (e.g., 512) holding the signal terminal (e.g., 12), wherein the wafer housing elastic arm (e.g., 121) prevents the signal terminal (e.g., 12) from depinning in the connector housing (e.g., 10), and the wafer housing projection (e.g., 122) limits the signal terminal (e.g., 12) from rotating in the housing (e.g., 10) when an external force is applied; the low-power terminal (e.g., 13) comprises a low-power terminal projection (e.g., 131) and a low-power terminal detent (e.g., 132), and the low-power terminal projection (e.g., 131) and the low-power terminal detent (e.g., 132) are both in interference fit with the connector housing (e.g., 10) to provide a retention force between the low-power terminal (e.g., 13) and the connector housing (e.g., 10).
2. The high-current right-angle board connector according to aspect 1, wherein the connector housing (e.g., 10) comprises a first slot (e.g., 101); a second slot (e.g., 102) and a third slot (e.g., 103); the high-power terminal (e.g., 11) is mounted in the first slot (e.g., 101); the signal terminal (e.g., 12) is mounted in the second slot (e.g., 102), and the low-power terminal (e.g., 13) is mounted in the third slot (e.g., 103).
3. The high-current right-angle board connector according to aspect 2, wherein a high-power terminal elastic arm (e.g., 113) is further provided on the high-power terminal (e.g., 11), and the high-power terminal elastic arm (e.g., 113) cooperates with the groove (e.g., 20) on the connector housing (e.g., 10) to provide a retention force between the high-power terminal (e.g., 11) and the connector housing (e.g., 10).
4. The high-current right-angle board connector according to aspect 3, wherein the groove (e.g., 20) is provided in the first slot (e.g., 101) to reduce fatigue of the high-power terminal elastic arm (e.g., 113) when the high-power terminal (e.g., 11) is interference-fitted with the connector housing.
5. The high-current right-angle board connector according to aspect 2, wherein a rib (e.g., 30) is provided in the second slot (e.g., 102), and the signal terminal (e.g., 12) and the rib (e.g., 30) are in an interference fit to provide a retention force between the signal terminal (e.g., 12) and the connector housing (e.g., 10).
6. The high-current right-angle board connector according to aspect 2, wherein the third slots (e.g., 103) are provided in a plurality and are evenly spaced apart in the connector housing (e.g., 10).
7. The high-current right-angle board connector according to aspect 1, wherein a lateral positioning projection (e.g., 602) is further provided on the low-power terminal (e.g., 13).
8. The high-current right-angle board connector according to aspect 1, further comprising a board (e.g., 60), wherein the high-current right-angle board connector is soldered on the board (e.g., 60) for signal and current control.
9. The high-current right-angle board connector according to aspect 1, wherein a recess (e.g., 70) is provided on the connector housing (e.g., 10) to meet electrical performance requirements of the low-power terminal (e.g., 13) to withstand high voltage.
10. A high-current composite board connector, comprising a connector housing (e.g., 710) and a high-power terminal (e.g., 720), a signal terminal (e.g., 730) and a low-power (e.g., 740) located in the connector housing (e.g., 710), wherein: the high-power terminal (e.g., 720) is mounted in the connector housing (e.g., 710) through a first detent (e.g., 1050) and a second detent (e.g., 1060); a high-power terminal elastic arm (e.g., 821) and a high-power terminal projection (e.g., 922) are provided on the high-power terminal (e.g., 720) to facilitate mounting the high-power terminal (e.g., 720) into the connector housing (e.g., 710); a wafer housing elastic arm (e.g., 1231) and a wafer housing projection (e.g., 1232) are provided on the wafer housing (e.g., 1230) to facilitate mounting the signal terminal (e.g., 730) into the connector housing (e.g., 710); a low-power terminal elastic arm (e.g., 1341) is provided on the low-power terminal (e.g., 740) to facilitate mounting the low-power terminal (e.g., 740) into the connector housing (e.g., 710).
11. The high-current composite board connector according to aspect 10, wherein the connector housing (e.g., 710) is provided therein with a first housing (e.g., 711), a second housing (e.g., 712) and a third housing (e.g., 713) for holding the high-power terminal (e.g., 720), the signal terminal (e.g., 730) and the low-power terminal (e.g., 740) respectively.
12. The high-current composite board connector according to aspect 11, wherein a groove (e.g., 8111) is provided in the first housing (e.g., 711), and the groove (e.g., 8111) cooperates with the high-power terminal (e.g., 720).
13. The high-current composite board connector according to aspect 11, wherein a recess (e.g., 9112) is provided in the first housing (e.g., 711), and the recess (e.g., 9112) cooperates with the high-power terminal projection (e.g., 922).
14. The high-current composite board connector according to aspect 11, wherein a plurality of ribs (e.g., 1121) are provided in the second housing (e.g., 712), and the ribs (e.g., 1121) cooperate with the signal wafer (e.g., 500) to facilitate positioning the signal terminal (e.g., 730).
15. The high-current composite board connector according to aspect 11, wherein a recess (e.g., 1122) is provided on the second housing (e.g., 712), and the recess (e.g., 1122) cooperates with the wafer housing projection (e.g., 1232).
16. The high-current composite board connector according to aspect 10, wherein the low-power terminal elastic arm (e.g., 1341) is an arc-shaped structure to facilitate positioning the low-power terminal (e.g., 740).
17. The high-current composite board connector according to aspect 10, wherein a plurality of guiding projections (e.g., 770) are provided on the connector housing (e.g., 710) to facilitate positioning and mounting the connector housing (e.g., 710).
18. The high-current composite board connector according to aspect 10, further comprising a board (e.g., 780), wherein the connector is soldered on the board (e.g., 780) for current and signal control.
19. An electrical connector (e.g., 100, 700) comprising a housing (e.g., 10, 710) comprising a first section, a second section, and a third section, the second section joining the first section and the third section; a plurality of first terminals (e.g., 11, 720) held in the first section of the housing, each of the plurality of first terminals configured to carry a first maximum current; a plurality of second terminal wafers (e.g., 500, 1200) held in the second section of the housing, each of the plurality of second terminal wafers comprising a plurality of second terminals (e.g., 12, 730) held by a wafer housing (e.g., 512); and a plurality of third terminals (e.g., 13, 740) held in the third section of the housing, each of the plurality of third terminals configured to carry a second maximum current less than the first maximum current.
20. The electrical connector of aspect 19, wherein the first section of the housing comprises a plurality of first slots (e.g., 101), each first slot holding a plurality of first terminals; the second section of the housing comprises a plurality of second slots (e.g., 102), each second slot holding a respective second terminal wafer of the plurality of second terminal wafers; and the third section of the housing comprises a plurality of third slots (e.g., 103), each third slot holding a respective third terminal of the plurality of third terminals.
21. The electrical connector of aspect 20, wherein the first section of the housing comprises a plurality of first grooves (e.g., 20, 8111), and a plurality of second grooves (e.g., 50); and each of the plurality of first terminals comprises a mating end, and a tail, and an intermediate portion between the mating end and the tail, the intermediate portion comprising an elastic arm (e.g., 113, 821) configured to engage a respective first groove of the plurality of first grooves and a projection (e.g., 111, 922) configured to engage a respective second groove of the plurality of second grooves.
22. The electrical connector of aspect 21, wherein, for each of the plurality of first terminals, the intermediate portion comprises a detent (e.g., 112, 1050, 1060) configured to engage a top of the first section of the housing.
23. The electrical connector of aspect 20, wherein the second section of the housing comprises a plurality of recesses (e.g., 80, 1122); and the wafer housing of each of the plurality of second terminal wafers comprises a projection (e.g., 122, 1232) disposed in a respective recess of the plurality of recesses.
24. The electrical connector of aspect 23, wherein, for each of the plurality of second terminal wafers, the wafer housing comprises an elastic arm (e.g., 121, 1231) configured to engage a top of the second section of the housing.
25. The electrical connector of aspect 23, wherein the second section of the housing comprises a plurality of ribs (e.g., 30) protruding into respective second slots; and the wafer housing of each of the plurality of second terminal wafers is configured to engage ribs of the plurality of ribs protruding into the respective second slot.
26. The electrical connector of aspect 19, wherein the third section of the housing comprises a plurality of grooves (e.g., 102); and each of the plurality of third terminals comprises a mating end, and a tail, and an intermediate portion between the mating end and the tail, the intermediate portion comprising a projection configured to engage a respective groove of the plurality of grooves of the third section of the housing.
27. An electrical connector (e.g., 100, 700) comprising a housing (e.g., 10, 710) comprising a first section comprising a plurality of first slots (e.g., 101), a second section comprising a plurality of second slots (e.g., 102), and a third section comprising a plurality of third slots (e.g., 103), the second section joining the first section and the third section; a plurality of pairs of first terminals (e.g., 11, 720) held in the first section of the housing, each pair of the plurality of pairs of first terminals disposed in a respective first slot; a plurality of second terminal wafers (e.g., 500, 1200) held in the second section of the housing, each of the plurality of second terminal wafers comprising a plurality of second terminals (e.g., 12, 730) held by a wafer housing, each of the plurality of second terminal wafers disposed in a respective second slot; and a plurality of third terminals (e.g., 13, 740) held in the third section of the housing, each of the plurality of third terminals disposed in a respective third slot.
28. The electrical connector of aspect 27, wherein the second section and the third section are separated by a wall (e.g., 202); and the first section and the second section are separated by a partial wall (e.g., 204) having a plurality of projections (e.g., 206) extending therefrom in a mating direction of the electrical connector.
29. The electrical connector of aspect 28, wherein adjacent first slots of the plurality of first slots are separated by respective partial walls (e.g., 208) each having a plurality of projections (e.g., 211) extending therefrom in the mating direction of the electrical connector.
30. The electrical connector of aspect 28, wherein adjacent third slots of the plurality of third slots are separated by respective partial walls (e.g., 210) each having a plurality of projections (e.g., 212) extending therefrom in the mating direction of the electrical connector.
31. The electrical connector of aspect 27, wherein each first terminal of the plurality of pairs of first terminals comprises a mating end, and a tail, and an intermediate portion between the mating end and the tail; each of the plurality of second terminals comprises a mating end extending beyond a first edge of the wafer housing, and a tail extending beyond a second edge of the wafer housing, and an intermediate portion between the mating end and the tail; and each of the plurality of third terminals comprises a mating end, and a tail, and an intermediate portion between the mating end and the tail.
32. The electrical connector of aspect 31, wherein the mating ends of the first terminals (e.g., 11) are shaped as beams; and the mating ends of the second and third terminals (e.g., 12, 13) are shaped as blades.
33. The electrical connector of aspect 31, wherein the mating ends of the first terminals (e.g., 720) are shaped as blades; and the mating ends of the second and third terminals (e.g., 730, 740) are shaped as beams.
34. The electrical connector of aspect 32, wherein each first terminal comprises a first side and a second side opposite the first side; the mating end of each first terminal comprises a plurality of beams each having a contact face (e.g., 402) on one of the first and second sides; and the intermediate portion of each first terminal comprises a projection (e.g., 111) protruding from the one of the first and second sides, and an elastic arm (e.g., 113) extending outwardly from the one of the first and second sides.
35. The electrical connector of aspect 33, wherein each third terminal comprises a first side and a second side opposite the first side; the mating end of each third terminal comprises a first beam (e.g., 1302), and a second beam (e.g., 1304) looped around the first beam and extending outwardly from one of the first and second sides; and the intermediate portion of each third terminal comprises an elastic arm (e.g., 1341) extending outwardly from the one of the first and second sides.
36. An electrical connector (e.g., 100, 700) comprising a housing (e.g., 10, 710) comprising a first section comprising a plurality of first slots (e.g., 101), a second section comprising a plurality of second slots (e.g., 102), and a third section comprising a plurality of third slots (e.g., 103), the second section joining the first section and the third section; a plurality of first terminals (e.g., 10, 710) held in the first section of the housing and disposed in respective first slots, each of the plurality of first terminals comprising an elastic arm configured to engage an adjacent side a respective first slot; a plurality of second terminal wafers (e.g., 500, 1200) held in the second section of the housing and disposed in respective second slots, each of the plurality of second terminal wafers comprising a plurality of second terminals held by a wafer housing, the wafer housing comprises an elastic arm configured to engage a top of the second section of the housing; and a plurality of third terminals (e.g., 13, 749) held in the third section of the housing and disposed in respective third slots.
37. The electrical connector of aspect 36, wherein the first and third sections of the housing comprise guiding projections (e.g., 170, 770) extending from a top.
38. The electrical connector of aspect 36, wherein, for each of the plurality of second terminal wafers, the wafer housing comprises a pair of projections (e.g., 122, 1232) on opposite sides and configured to engage sides of a respective second slot.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, in some embodiments, the aspects of the present disclosure may not be limited to right angle connectors. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front”, “rear”, “upper”, “lower”, “left”, “right”, “transverse direction”, “vertical direction”, “perpendicular”, “horizontal”, “top”, “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. In some embodiments, various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector comprising:
a housing comprising a first section, a second section, and a third section, the second section joining the first section and the third section;
a plurality of first terminals held in the first section of the housing, each of the plurality of first terminals configured to carry a first maximum current;
a plurality of second terminal wafers held in the second section of the housing, each of the plurality of second terminal wafers comprising a plurality of second terminals held by a wafer housing; and
a plurality of third terminals held in the third section of the housing, each of the plurality of third terminals configured to carry a second maximum current less than the first maximum current.

2. The electrical connector of claim 1, wherein:
the first section of the housing comprises a plurality of first slots, each first slot holding a plurality of first terminals;
the second section of the housing comprises a plurality of second slots, each second slot holding a respective second terminal wafer of the plurality of second terminal wafers; and
the third section of the housing comprises a plurality of third slots, each third slot holding a respective third terminal of the plurality of third terminals.

3. The electrical connector of claim 2, wherein:
the first section of the housing comprises a plurality of first grooves, and a plurality of second grooves; and
each of the plurality of first terminals comprises a mating end, and a tail, and an intermediate portion between the mating end and the tail, the intermediate portion comprising an elastic arm configured to engage a respective first groove of the plurality of first grooves and a projection configured to engage a respective second groove of the plurality of second grooves.

4. The electrical connector of claim 3, wherein, for each of the plurality of first terminals:
the intermediate portion comprises a detent configured to engage a top of the first section of the housing.

5. The electrical connector of claim 2, wherein:
the second section of the housing comprises a plurality of recesses; and
the wafer housing of each of the plurality of second terminal wafers comprises a projection disposed in a respective recess of the plurality of recesses.

6. The electrical connector of claim 5, wherein, for each of the plurality of second terminal wafers:
the wafer housing comprises an elastic arm configured to engage a top of the second section of the housing.

7. The electrical connector of claim 5, wherein:
the second section of the housing comprises a plurality of ribs protruding into respective second slots; and
the wafer housing of each of the plurality of second terminal wafers is configured to engage ribs of the plurality of ribs protruding into the respective second slot.

8. The electrical connector of claim 1, wherein:
the third section of the housing comprises a plurality of grooves; and
each of the plurality of third terminals comprises a mating end, and a tail, and an intermediate portion between the mating end and the tail, the intermediate portion comprising a projection configured to engage a respective groove of the plurality of grooves of the third section of the housing.

9. An electrical connector comprising:
a housing comprising a first section comprising a plurality of first slots, a second section comprising a plurality of second slots, and a third section comprising a plurality of third slots, the second section joining the first section and the third section;
a plurality of pairs of first terminals held in the first section of the housing, each pair of the plurality of pairs of first terminals disposed in a respective first slot;
a plurality of second terminal wafers held in the second section of the housing, each of the plurality of second terminal wafers comprising a plurality of second terminals held by a wafer housing, each of the plurality of second terminal wafers disposed in a respective second slot; and
a plurality of third terminals held in the third section of the housing, each of the plurality of third terminals disposed in a respective third slot.

10. The electrical connector of claim 9, wherein:
the second section and the third section are separated by a wall; and
the first section and the second section are separated by a partial wall having a plurality of projections extending therefrom in a mating direction of the electrical connector.

11. The electrical connector of claim 10, wherein:
adjacent first slots of the plurality of first slots are separated by respective partial walls each having a plurality of projections extending therefrom in the mating direction of the electrical connector.

12. The electrical connector of claim 10, wherein:
adjacent third slots of the plurality of third slots are separated by respective partial walls each having a plurality of projections extending therefrom in the mating direction of the electrical connector.

13. The electrical connector of claim 9, wherein:
each first terminal of the plurality of pairs of first terminals comprises a mating end, and a tail, and an intermediate portion between the mating end and the tail;
each of the plurality of second terminals comprises a mating end extending beyond a first edge of the wafer housing, and a tail extending beyond a second edge of the wafer housing, and an intermediate portion between the mating end and the tail; and
each of the plurality of third terminals comprises a mating end, and a tail, and an intermediate portion between the mating end and the tail.

14. The electrical connector of claim 13, wherein:
the mating ends of the first terminals are shaped as beams; and
the mating ends of the second and third terminals are shaped as blades.

15. The electrical connector of claim 13, wherein:
the mating ends of the first terminals are shaped as blades; and
the mating ends of the second and third terminals are shaped as beams.

16. The electrical connector of claim 14, wherein:
each first terminal comprises a first side and a second side opposite the first side;
the mating end of each first terminal comprises a plurality of beams each having a contact face on one of the first and second sides; and
the intermediate portion of each first terminal comprises a projection protruding from the one of the first and second sides, and an elastic arm extending outwardly from the one of the first and second sides.

17. The electrical connector of claim 15, wherein:
each third terminal comprises a first side and a second side opposite the first side;
the mating end of each third terminal comprises a first beam, and a second beam looped around the first beam and extending outwardly from one of the first and second sides; and
the intermediate portion of each third terminal comprises an elastic arm extending outwardly from the one of the first and second sides.

18. An electrical connector comprising:
a housing comprising a first section comprising a plurality of first slots, a second section comprising a plurality of second slots, and a third section comprising a plurality of third slots, the second section joining the first section and the third section;
a plurality of first terminals held in the first section of the housing and disposed in respective first slots, each of the plurality of first terminals comprising an elastic arm configured to engage an adjacent side a respective first slot;
a plurality of second terminal wafers held in the second section of the housing and disposed in respective second slots, each of the plurality of second terminal wafers comprising a plurality of second terminals held by a wafer housing, the wafer housing comprises an elastic arm configured to engage a top of the second section of the housing; and
a plurality of third terminals held in the third section of the housing and disposed in respective third slots.

19. The electrical connector of claim 18, wherein:
the first and third sections of the housing comprise guiding projections extending from a top.

20. The electrical connector of claim 18, wherein, for each of the plurality of second terminal wafers:
the wafer housing comprises a pair of projections on opposite sides and configured to engage sides of a respective second slot.
